(19) United States
(12) Patent Application Publication
(10) Pub. No.: US 2018/0247342 A1
(43) Pub. Date: Aug. 30, 2018

(54) Content Creation Method and System

(71) Applicant: Humery Pty Ltd, Cherrybrook (AU)

(72) Inventor: Joel James Montgomery, Cherrybrook (AU)

(21) Appl. No.: 15/756,291

(22) PCT Filed: Sep. 1, 2016
(86) PCT No.: PCT/AU2016/000306

§ 371 Date: Feb. 28, 2018

Related U.S. Application Data
(60) Provisional application No. 62/212,655, filed on Sep. 1, 2015.

(51) Int. Cl. G06Q 30/02; G06F 21/62; G06F 17/30

(52) U.S. Cl. CPC G06Q 30/0276; G06Q 50/01; G06F 17/30876; G06F 21/6218

(57) ABSTRACT

A computer-implemented method and system for generating a digital information campaign on behalf of an entity for distribution to a digital contact list maintained by the entity is disclosed. The system comprises a database server including a database of digital content items, the database including at least one sponsored digital content item originating from a sponsor of the digital information campaign and at least one non-sponsored content item. The system also includes a rules engine for the sponsor to generate a composition rule for determining a composition of the digital information campaign based on the database of digital content items, the sponsor and the entity with the composition rule of the digital marketing campaign requiring at least one sponsored content item to be included in the digital marketing campaign. The system further includes a content compiler for generating the digital marketing campaign in accordance with the composition rule.

### PRIORITY DOCUMENTS

The present application claims priority from U.S. Provisional Patent Application No. 62/212,655 titled “CONTENT CREATION METHOD AND SYSTEM” and filed on 1 Sep. 2015, the content of which is hereby incorporated by reference in its entirety.

### TECHNICAL FIELD

The present disclosure relates to generation of content for distribution. In one form, the present disclosure relates to the generation of digital content for distribution including sponsored material.

### BACKGROUND

Digital information campaigns are an effective way to distribute content broadly and for an entity such as a commercial operation or organisation they offer an opportunity for the entity to promote new products and services and/or to provide information to their customers and/or subscribers. A digital information campaign such as a marketing campaign may take many forms. As an example, a digital marketing campaign may comprise the distribution of marketing material by an entity to a contact list associated with that entity. In one example, the marketing material may comprise an email that is sent to an electronic contact list maintained by the entity, the electronic contact list comprising contacts, clients, customers and/or subscribers of the entity. In this example, the email may comprise the marketing material itself or it may include an attachment such as a newsletter or brochure or other digital content such as a video, image or hypertext link either attached to or embedded in the email.

In another example, the digital information campaign may comprise uploading or posting of digital information such as marketing material to a social media site which will then be automatically posted to a digital contact list of social media handles or usernames comprising “followers” of the entity on the social media site, with the marketing material then becoming part of the “feed” of those followers. In this manner, the marketing material may comprise digital content such as an article, video or image, or a hypertext link to other digital material which then appears in the feed of users of the social media site.

Digital information campaigns may also include a timed sequence of digital events. In one non-limiting example, in the context of social media sites and a digital marketing campaign, the campaign may comprise a series of “teaser” updates or status posts spread over time and a subsequent video directed to the actual product or service being promoted which forms part of the feed of followers of the entity.

As would be appreciated, the generation of a digital information campaign is a complex, time consuming and expensive exercise which generally results in this type of marketing or promotional activity only being undertaken by large corporates who can afford to engage service providers to carry out the multiple activities involved. An important issue faced by these types of companies is that they are often one step removed from the direct consumers of their products and as a result do not have access to an electronic record identifying these consumers. As a consequence, they are unable to target their marketing campaigns appropriately to these direct consumers where a campaign would have the most effect and not be treated potentially as spam or unsolicited material.

The entities that maintain digital contact lists or databases of customers and/or subscribers are those that have direct contact with consumers, however, these entities are generally smaller and do not have the time or money to develop a digital marketing campaign. As noted above, the larger corporates that supply these entities would typically have the marketing budgets to assist an entity with their marketing; however, these entities regard their electronic customer databases as valuable and proprietary and as a consequence are unlikely to share their customer databases. This is because an entity would be concerned that their suppliers would attempt to communicate and/or sell directly to their customers or share their customer databases with competitors. Unfortunately, this results in these types of entities not being able to generate effective digital marketing campaigns to their customers.

### SUMMARY

In a first aspect, the present disclosure provides a computer-implemented system for generating a digital information campaign on behalf of an entity for distribution to a digital contact list maintained by the entity, comprising:

a database server including a database of digital content items, the database including at least one sponsored digital content item originating from a sponsor of the digital information campaign and at least one non-sponsored content item;

a rules engine for the sponsor to generate a composition rule for determining a composition of the digital information campaign based on the database of digital content items, the sponsor and the entity, the composition rule of the digital marketing campaign requiring at least one sponsored content item to be included in the digital marketing campaign; and

a content compiler for generating the digital marketing campaign in accordance with the composition rule.

In another form, the system further includes an approval engine for approving the digital marketing campaign.

In another form, the content compiler is operated by the entity to generate the digital marketing campaign in accordance with the composition rule for approval by the sponsor.

In another form, the content compiler is operated by the sponsor to generate the digital marketing campaign in accordance with the composition rule for approval by the entity.

In another form, the digital contact list is securely stored to prevent access by the sponsor on the database server and wherein the system further includes a distribution engine for distributing the digital marketing campaign to the digital contact list of the entity.

In another form, the at least one sponsored digital content item promotes a product and/or service provided by the sponsor.

In another form, the composition rule comprises one or more composition requirements.

In another form, the composition requirement defines a content characteristic of the digital information campaign.

In another form, the composition requirement includes any one of, or combination together of:

requiring default content to be included in the digital information campaign;

requiring one or more non-sponsored digital content items to be included in the digital information campaign;

requiring one or more classes or libraries of sponsored and/or non-sponsored digital content items to be included in the digital information campaign;

identifying one or more sponsored and/or non-sponsored digital content items not to be included in the digital information campaign;

identifying one or more classes or libraries of sponsored and/or non-sponsored digital content items not to be included in the digital information campaign

specifying a time period for which a sponsored or non-sponsored digital content item may be included in a digital information campaign;

specifying an order in which sponsored or non-sponsored digital content items may be distributed or published in a digital information campaign; or

specifying the minimum or maximum number of sponsored and/or non-sponsored digital content items to be included in the digital campaign.

In another form, the composition requirement defines a relationship between a sponsor and an entity.

In another form, the composition requirement includes any one of, or combination together of:

identifying those entities who will not accept or publish sponsored and/or non-sponsored digital content items from a sponsor;

identifying those entities who a sponsor will not generate a digital information campaign on behalf of; or

specifying for an entity the level of editorial control that they may have over the digital information campaign.

In another form, the composition requirement defines a relationship between a sponsor and another sponsor.

In another form, the composition requirement includes identifying a coexistence relationship between sponsors.

In another form, the digital marketing campaign includes at least one email, and wherein the digital contact list comprises email addresses.

In another form, the digital marketing campaign includes at least one social media post, and the digital contact list comprises social media handles or usernames.

In a second aspect, the present disclosure provides a computer-implemented system for generating a digital information campaign on behalf of an entity for distribution to a digital contact list maintained by the entity, comprising:

a database server including a database of digital content items, the database including at least one sponsored digital content item originating from a sponsor of the digital information campaign and at least one non-sponsored content item;

computer memory holding computer program instructions in communication with one or more processors that when executed by the one or more processors, cause the one or more processors to perform operations comprising:
initiating a rules engine communicatively coupled to the database server and having a user interface for the sponsor to generate a composition rule for determining a composition of the digital information campaign based on the database of digital content items, the sponsor and the entity, the composition rule of the digital marketing campaign requiring at least one sponsored content item to be included in the digital marketing campaign; and
initiating a content compiler communicatively coupled to the database server for generating the digital marketing campaign in accordance with the composition rule.

In another form, the one or more processors perform operations comprising:

securely storing the digital contact list to prevent access by the sponsor on the database server; and

distributing the digital marketing campaign to the digital contact list of the entity.

In a third aspect, the present disclosure provides a system for generating a digital information campaign on behalf of an entity for distribution to a digital contact list maintained by the entity comprising:

a database server comprising one or more processors and including a database of digital content items, the database including at least one sponsored digital content item originating from a sponsor of the digital information campaign and at least one non-sponsored content item;

a rules engine module comprising one or more processors and communicatively coupled to the database, the rules engine module configured to generate a composition rule for determining a composition of the digital information campaign based on the database of digital content items, the sponsor and the entity, the composition rule of the digital marketing campaign requiring at least one sponsored content item to be included in the digital marketing campaign;

a content compiler module comprising one or more processors and communicatively coupled to the database server, the content compiler module configured to generate the digital marketing campaign in accordance with the composition rule.

In another form, the digital contact list is securely stored to prevent access by the sponsor on the database server and further including a distribution module comprising one or more processors and communicatively coupled to the content compiler module and the database server, the distribution module configured to distribute the digital marketing campaign to the digital contact list of the entity.

In a fourth aspect, the present disclosure provides a computer-implemented method for generating a digital information campaign on behalf of an entity for distribution to a digital contact list maintained by the entity, comprising:

forming a database of digital content items, the database including at least one sponsored content item originating from a sponsor of the digital information campaign and at least one non-sponsored content item;

generating by the sponsor a composition rule for determining a composition of the digital information campaign based on the database of digital content items, the sponsor and the entity, the composition rule of the digital marketing campaign requiring at least one sponsored content item to be included in the digital marketing campaign;

generating the digital marketing campaign in accordance with the composition rule.

In another form, the method further includes approving by the sponsor the digital marketing campaign.

In another form, the method further includes approving by the entity the digital marketing campaign.

In another form, the method further includes:

securely storing the digital contact list to prevent access by the sponsor; and

distributing the digital marketing campaign to the digital contact list.

In a fifth aspect, the present disclosure provides a computer-implemented method for generating a digital information campaign on behalf of an entity for distribution to a digital contact list maintained by the entity, comprising:

forming a database of digital content items on a database server, the database including at least one sponsored content item originating from a sponsor of the digital information campaign and at least one non-sponsored content item;

generating by the sponsor on one or more processors communicatively coupled to the database a composition rule for determining a composition of the digital information campaign based on the database of digital content items, the sponsor and the entity, the composition rule of the digital marketing campaign requiring at least one sponsored content item to be included in the digital marketing campaign; and

generating by the one or more processors communicatively coupled to the database the digital marketing campaign in accordance with the composition rule.

In another form, the method further includes securely storing the digital contact list to prevent access by the sponsor on the database server and distributing by the one or more processors the digital marketing campaign to the digital contact list of the entity.

In a sixth aspect, the present disclosure provides the digital information campaign formed in accordance with the fourth or fifth aspects of the disclosure.

In a seventh aspect, the present disclosure provides a computer-implemented system for generating a digital information campaign on behalf of one or more entities for distribution to respective digital contact lists maintained by the one or more entities, wherein the digital information campaign is sponsored by a sponsor, the system comprising:

an entity registration module for registering a plurality of entities, wherein the entity registration module receives and stores entity info′ illation related to each entity including the respective digital contact list maintained by each entity, wherein the respective digital contact list is securely stored to prevent access by the sponsor;

a digital information campaign group compiler for determining a sponsored campaign group consisting of the one or more entities based on matching the one or more entities to the sponsor;

a database server including a database of digital content items, the database including at least one sponsored digital content item originating from the sponsor and at least one non-sponsored content item;

a rules engine for the sponsor to generate a composition rule for determining a composition of the digital information campaign based on the database of digital content items, the sponsor and the sponsored campaign group, the composition rule of the digital marketing campaign requiring at least one sponsored content item to be included in the digital information campaign; and

a content compiler for generating the digital information campaign in accordance with the composition rule and the sponsored campaign group for distribution to respective digital contact lists maintained by one or more entities.

In another form, the sponsor is a supplier of goods and/or services to the one or more entities and the one or more entities directly sell goods and/or services to consumers.

In another form, the entity information includes the goods and/or services sold by the entity and matching the one or more entities and the sponsor includes comparing the goods and/or services sold by a respective entity and those supplied by the sponsor.

In another form, comparing the goods and/or services sold by the respective entity includes determining a brand identifier of a product sold by the respective entity and matching that to a brand identifier of the sponsor to determine the sponsored campaign group.

In another form, the system further includes a distribution engine for distributing the digital marketing campaign to the digital contact list of the entity.

In an eighth aspect, the present disclosure provides a computer-implemented method for generating a digital information campaign on behalf of one or more entities for distribution to respective digital contact lists maintained by the one or more entities, wherein the digital information campaign is sponsored by a sponsor, comprising:

forming a database of digital content items on a database server, the database including at least one sponsored content item originating from a sponsor of the digital information campaign and at least one non-sponsored content item;

registering a plurality of entities including receiving and storing entity information related to each entity including the respective digital contact list maintained by each entity, wherein the respective digital contact lists are securely stored to prevent access by the sponsor;

matching the one or more entities to the sponsor to compile a sponsored campaign group;

generating a composition rule for determining a composition of the digital information campaign based on the database of digital content items, the sponsor and the sponsored campaign group, the composition rule of the digital marketing campaign requiring at least one sponsored content item to be included in the digital marketing campaign; and

generating the digital marketing campaign in accordance with the composition rule.

In another form, the sponsor is a supplier of goods and/or services to the one or more entities and the one or more entities directly sell goods and/or services to consumers.

In another form, the entity information includes the goods and/or services sold by the entity and matching the one or more entities to the sponsor includes comparing the goods and/or services sold by a respective entity and those supplied by the sponsor.

In another form, comparing the goods and/or services sold by the respective entity includes determining a brand identifier of a product sold by the respective entity and matching that to a brand identifier of the sponsor to determine the sponsored campaign group.

In another form, the method further includes approving by the sponsor the digital marketing campaign.

In another form, the method further includes approving by the entity the digital marketing campaign.

In another form, the method further includes distributing the digital marketing campaign to the respective digital contact lists of the one or more entities.

### BRIEF DESCRIPTION OF DRAWINGS

Embodiments of the present disclosure will be discussed with reference to the accompanying drawings wherein:

FIG. 1 is a schematic of a computer-implemented system for generating a digital information campaign according to an illustrative embodiment;

FIG. 2 is a schematic of a computer-implemented system for generating a digital information campaign according to another illustrative embodiment;

FIG. 3 is a flowchart of a method for generating a digital information campaign according to an illustrative embodiment;

FIG. 4 is a flowchart of a method for generating a digital information campaign according to another illustrative embodiment;

FIG. 5 is a flowchart of a method for generating a digital information campaign according to yet another illustrative embodiment;

FIG. 6 is a schematic of a computer-implemented system for generating a digital information campaign according to yet another illustrative embodiment;

FIG. 7 is a user interface screen of the content compiler illustrated in FIG. 1 according to an illustrative embodiment operable to define a template for the digital information campaign;

FIG. 8 is a user interface screen of the content compiler illustrated in FIG. 1 according to an illustrative embodiment operable to select a non-sponsored digital content item from the database of digital content items;

FIG. 9 is a user interface screen of the content compiler illustrated in FIG. 1 according to an illustrative embodiment operable to select a sponsored digital content item from the database of digital content items;

FIG. 10 is a user interface screen of the rules engine illustrated in FIG. 1 according to an illustrative embodiment operable to define a sponsor entity relationship;

FIG. 11 is a user interface screen of the rules engine illustrated in FIG. 1 according to an illustrative embodiment operable to define co-existence relationships between sponsors;

FIG. 12 is a user interface screen of the rules engine illustrated in FIG. 1 according to an illustrative embodiment operable to define the minimum and maximum sponsored and non-sponsored digital content items that may be included in the digital information campaign;

FIG. 13 is a user interface screen of the content compiler illustrated in FIG. 1 according to an illustrative embodiment setting out the non-sponsored digital content items for a digital information campaign occurring over an extended time period;

FIG. 14 is a schematic of a computer-implemented system for generating a digital information campaign according to another illustrative embodiment;

FIGS. 15A-E are user interface screens of the entity registration module illustrated in FIG. 14 according to an illustrative embodiment setting out the information obtained from an entity for registration; and

FIG. 16 is a flowchart of a method for generating a digital information campaign according to a further illustrative embodiment.

In the following description, like reference characters designate like or corresponding parts throughout the figures.

### DESCRIPTION OF EMBODIMENTS

Referring now to FIG. 1, there is shown a computer-implemented system 100 for generating a digital information campaign on behalf of an entity. In this illustrative embodiment, the entity may be any organisation or individual, commercial or otherwise, who maintains a digital contact list for the sending of digital information to.

The digital contact list may relate to the contacts, clients, customers and/or subscribers of the entity depending on the nature of the entity. In one non-limiting example, the entity may be a commercial service provider and the contact list would be primarily comprised of clients of the commercial service provider. In another non-limiting example, the entity may be an information provider providing information to a contact list comprised primarily of subscribers desiring to be kept up to date with information in that general area of interest.

As would be appreciated, the individual digital contact identifiers of the digital contact list may include email addresses or social media platform user names or any electronic identifier that allows digital information to be sent to that electronic identifier. As would be appreciated, the electronic identifier may be platform specific such as in the case of a social media platform where different electronic identifiers or handles may be used specific to that platform but which relate to the same subscriber or recipient.

Digital information campaign generation system 100 comprises a database server 110 including a database of digital content items that includes at least one sponsored content item 120 and at least one non-sponsored content item 125. The digital content items may comprise any type of content capable of being stored in digital form, including, but not limited to, text, audio, images, video, hypertext links and/or animations. Examples of types of content include, but are not limited to, articles, promotions, surveys and/or announcements.

The database may be any electronic database capable of storing the digital content items. In one non-limiting example, the database is a relational database. In yet another example, the database is a Structured Query Language (SQL) database capable of being queried by SQL commands.

Sponsored content items 120 are digital content items that originate from, or are authorised by, the sponsor of the digital information campaign who is seeking to include the sponsored content items in the digital information campaign for eventual distribution to a contact list maintained by the entity. In one example, the sponsored content items directly promote the sponsor. In other examples, the sponsored content items may be primarily informational and not necessarily make direct reference to the sponsor. As would be appreciated, the sponsored content items 120 need not necessarily be created by the sponsor and may be created by other parties but then identified as a sponsored content item that the sponsor may wish to include in any digital information campaign.

Non-sponsored content items 125 are digital content items that have no sponsored content and may originate from sources that include, but are not limited to, other entities or sponsors, publications, reference material or the news media. As would be appreciated, non-sponsored digital content items may include references to a sponsor's products or services but this content has been developed independently and without any input from the sponsor.

New digital content items 120, 125 may be loaded onto database 110 by the sponsor, entity or other third parties. Both sponsored and non-sponsored digital content items may also be classified into respective classes or libraries according to classification criteria including, but not limited to, subject matter, age of articles or target audience.

Digital information campaign generation system 100 further comprises a rules engine or module 130 and a content compiler 140. Rules engine 130 allows the sponsor of the digital information campaign to generate a composition rule 130A that determines the composition of the digital information campaign based on the database 110 of digital content items, the sponsor and the entity whose digital contact list the digital information campaign will be delivered or distributed to. In this embodiment, rules engine 130 includes a graphical user interface implemented on display 135 for the sponsor, or an operator acting on behalf of the sponsor, to generate the composition rule which will be comprised of one or more composition requirements.

Composition requirements may fall into a number of requirement categories that include, but are not limited to, defining the overall content characteristics of the digital information campaign, defining a relationship between a sponsor and an entity, or defining a relationship between a sponsor and another sponsor.

Examples of composition requirements in the requirement category directed to defining a content characteristic of the digital information include, but are not limited, to:
requiring default content to be included in the digital information campaign;
requiring at least one sponsored digital content item to be included in the digital information campaign;
requiring one or more non-sponsored digital content items to be included in the digital information campaign;
requiring one or more classes or libraries of sponsored and/or non-sponsored digital content items to be included in the digital information campaign;
identifying one or more sponsored and/or non-sponsored digital content items not to be included in the digital information campaign;
identifying one or more classes or libraries of sponsored and/or non-sponsored digital content items not to be included in the digital information campaign;
specifying a time period for which a sponsored or non-sponsored digital content item may be included in a digital information campaign;
specifying an order in which sponsored or non-sponsored digital content items may be distributed or published in a digital information campaign; or
specifying the minimum or maximum number of sponsored and/or non-sponsored digital content items to be included in the digital campaign.

Examples of composition requirements that are in the requirement category directed to defining a relationship between a sponsor and an entity include, but are not limited, to:
identifying those entities who will not accept or publish sponsored and/or non-sponsored digital content items from a sponsor;
identifying those entities who a sponsor will not generate a digital information campaign on behalf of;
specifying for an entity the level of editorial control that they may have over the digital information campaign including whether the entity may edit or modify the digital information campaign and/or to specifically indicate the one or more sponsored and/or non-sponsored digital content items that the entity may edit or remove from the digital information campaign.

Examples of composition requirements that are in the requirement category directed to defining a relationship between a sponsor and another sponsor, include, but are not limited, to:
identifying a coexistence relationship between sponsors including identifying another sponsor whose sponsored and/or non-sponsored digital content items cannot be included in the digital information campaign.

A combination of the above composition requirements may then be taken together to form the composition rule that determines the composition of the digital information campaign.

In another example, a composition rule may be specified by a sponsor to apply to an individual entity and/or group of entities and/or for a particular time period.

Content compiler 140 then generates the digital marketing campaign in accordance with composition rule 130A for later distribution.

As would be appreciated, content compiler 140 may source entity specific data which may be stored in database 110 or any other suitable repository of information including databases maintained by the entity. Illustrative examples of entity specific data include, but are not limited to, customised images or logos, layout templates such as a newsletter template or the like, headers and/or footers.

The generation of the digital information campaign will depend on the distribution mode. In one non-limiting example, the distribution is by email and the digital information campaign will comprise one or more HTML documents that may be sent by email. In another example, the distribution is by short message service (SMS) text message and the digital information campaign will comprise one or more text messages comprised of plain text.

In another embodiment, the digital information campaign is computer code which is sent to an external platform, such as a social media platform, and interacts with the social media platform via an application programing interface (API) to source and display the sponsored and non-sponsored content items of the digital information campaign.

In one embodiment, the content compiler 140 may display allowable sponsored and non-sponsored content items 120, 125 in separate categories for selection in accordance with composition rule 130A. In another embodiment, one or more sponsored and non-sponsored content items may be stored in collections of similar content to form a library directed to particular subject matter as referred to above.

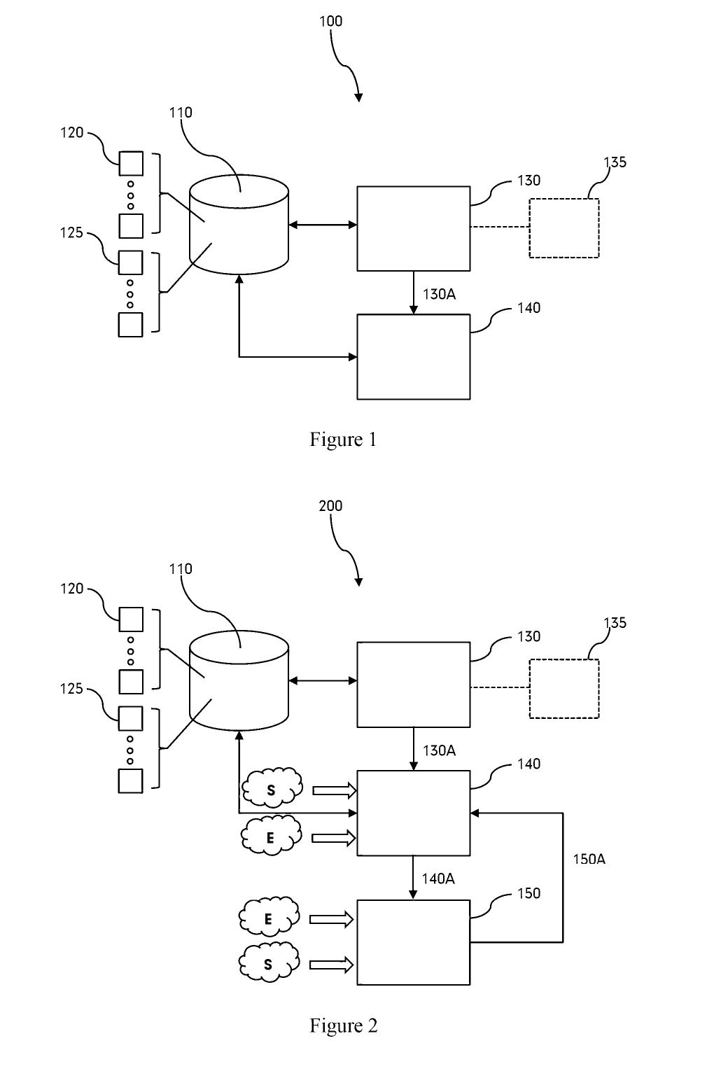

Referring now to FIG. 2, there is shown a computer-implemented system 200 for generating a digital information campaign on behalf of an entity according to an illustrative embodiment including further approval engine or module 150 for approving the digital marketing campaign 140A generated in accordance with composition rule 130A by content compiler 140.

In one example, where content compiler 140 is operated by, or under the authority of the sponsor S, approval engine 150 provides digital marketing campaign 140A to entity E for consideration and to determine an approval status. Where digital information campaign 140A is not approved, this information 150A is provided to content compiler 140 to allow digital marketing campaign 140A to be modified. This process may be repeated as required until approval is obtained. In another example, where content compiler 140 is operated by, or under the authority of the entity E, approval engine 150 provides digital marketing campaign 140A to sponsor S for consideration and to determine the approval status. As previously, where digital information campaign 140A is not approved, this information 150A is provided to content compiler 140 to allow digital marketing campaign 140A to be modified by, in this case, entity E.

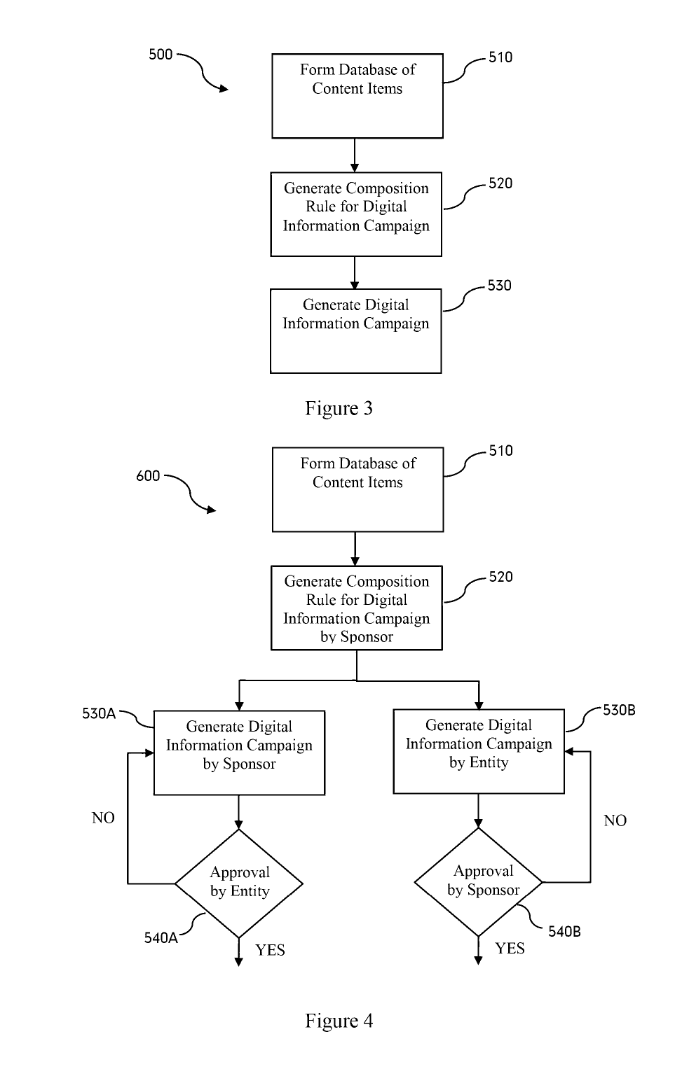

Referring now to FIG. 3, there is shown a flowchart of a method 500 for generating a digital information campaign on behalf of an entity for distribution to a digital contact list maintained by the entity. In this example, the digital information campaign is initiated by a sponsor seeking to distribute sponsored material in the form of one or more sponsored content items that will be included in the digital information campaign to be distributed to the entity's contact list. In this manner, the sponsor, which includes their agents or third party implementers authorised to act on the sponsor's behalf, facilitates the generation of the digital information campaign for the entity in satisfaction for distribution access to the entity's contact list. As would be appreciated, there is no requirement for the sponsor to have access to the details of the entity's digital contact list.

At step 510, a database of content items is formed which includes one or more sponsored and non-sponsored content items as has been previously discussed. As would be appreciated, the database may be a central or distributed digital or electronic database which is continually updated with sponsored content items which could pertain to many different sponsors for the generation of different digital information campaigns pertaining to those sponsors.

At step 520, a composition rule is generated by the sponsor that determines the composition of the digital marketing campaign. Here the sponsor ensures that any digital marketing campaign will include at least one sponsored content item without necessarily stipulating which particular sponsored content item is to form part of the digital information campaign.

At step 530, the digital information campaign is generated in accordance with the composition rule.

In one example embodiment, the sponsor and entity may agree initially that the digital information campaign generated in accordance with the composition rule may then be distributed without further approval from the entity to the entity's contact list.

Referring now to FIG. 4, there is shown a flowchart of a method 600 for generating a digital information campaign on behalf of an entity according to another embodiment including an approval stage or process. In this example, the digital information campaign is either generated by the sponsor 530A or entity 530B in accordance with the sponsor defined composition rule and is then made subject to approval by the entity 540A or by the sponsor 540B respectively who may then request modifications to the digital information campaign to be made by the sponsor or entity respectively on the basis that all modifications are still in accordance with the composition rule before final approval and distribution. In one example, this approval process may take the form of approving part of or alternatively the entire digital information campaign.

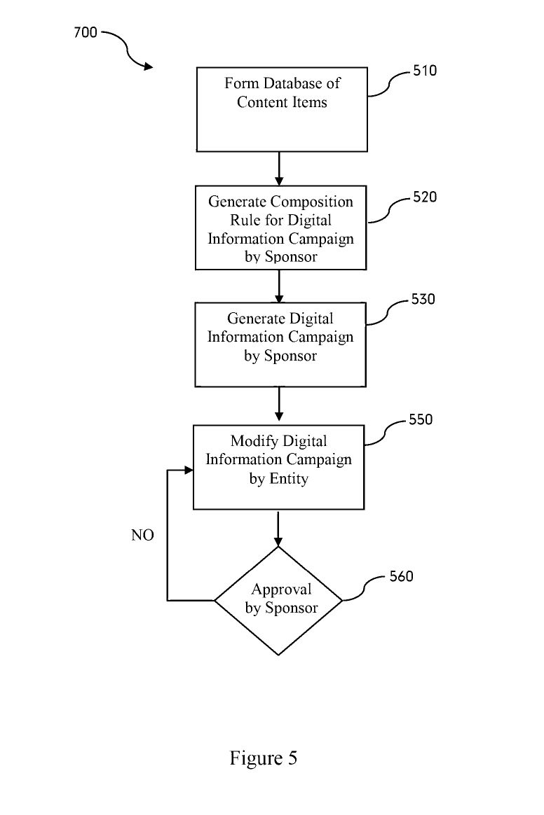

Referring now to FIG. 5, there is shown a flowchart of a method 700 for generating a digital information campaign on behalf of an entity according to another embodiment including an entity modification stage and sponsor approval stage. In this example, the entity at step 550 is able to modify the digital information campaign following generation by the sponsor, still in accordance with the composition rule, before final approval by the sponsor at step 560. Optionally, a final approval step by the entity may be incorporated.

The step of modifying the digital information campaign by the entity may include, but not be limited to, the addition, removal and/or substitution of content items provided that the composition rule is still satisfied. If the entity is unable to satisfy the sponsor determined composition rule then the digital information campaign is not distributed.

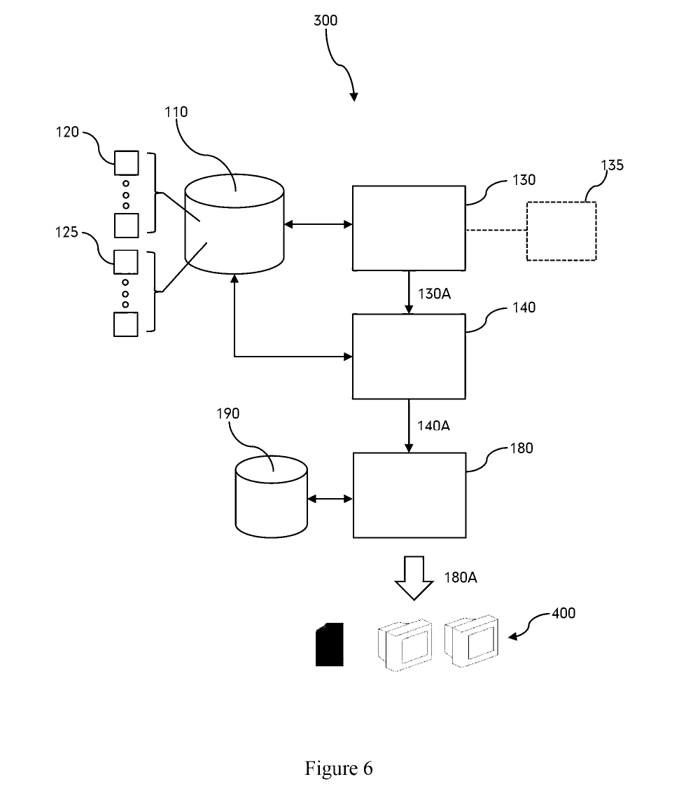

Referring now to FIG. 6, there is shown a computer-implemented system 300 for generating a digital information campaign on behalf of an entity including further distribution engine or module 180 that receives as input the digital information campaign 140A generated in accordance with composition rule 130A by content compiler 140.

Distribution engine or module 180 has access to the digital contact list 190 maintained by the entity but otherwise the digital contact list 190 is secured from access by the sponsor. Distribution engine 180 functions to distribute the digital information campaign to members 400 of the digital contact list who will receive the digital information campaign by various types of electronic devices connected to an information network such as the Internet. In one non-limiting example, the digital contact list 190 is a secured SQL database that may be queried by the distribution engine 180 to obtain individual contacts for the sending of the digital information campaign.

In another embodiment, distribution engine 180 will only distribute 180A the digital marketing campaign following any approval process that may be mandated by either the sponsor or entity such as depicted in FIG. 2.

In an embodiment, the entity may be a commercial supplier of computer products and the digital information campaign may be a digital marketing campaign comprising a newsletter in HTML or plain text format that has been generated by a sponsor who is a computer component supplier, where the newsletter contains an infomercial from the computer component supplier (ie, sponsored content item) as well as information articles that would be of general interest to the clients and customers on the contact list of the supplier of computer products. In this example, distribution of the digital marketing campaign would then involve the newsletter then being sent to the email addresses by the use of mail merge or other equivalent systems that will have access to the digital contact list in the form of email addresses and send the newsletter to these email addresses. In another embodiment, the newsletter may be formed as separate documents, such as a PDF document, which is then sent as an attachment to an email sent to these addresses.

In another embodiment, the entity may be a commercial supplier of computer products and the digital information campaign may be a series of social media posts made on behalf of the supplier onto the supplier's newsfeed for a given social media platform such as Twitter™, Facebook™ or Linked-In™. These posts are read by those users who subscribe to (or “follow”) the supplier's social media feed. Each post would consist of either a sponsored or non-sponsored content item, and the content would be scheduled to be posted over a pre-determined time period so as not to bombard the follower with multiple content items simultaneously. During configuration of the digital information campaign, the commercial supplier authenticates to their social platform via an interface that allows the system 100 to execute the campaign on behalf of the supplier without requiring on-going authentication for each posting of a sponsored or non-sponsored content item.

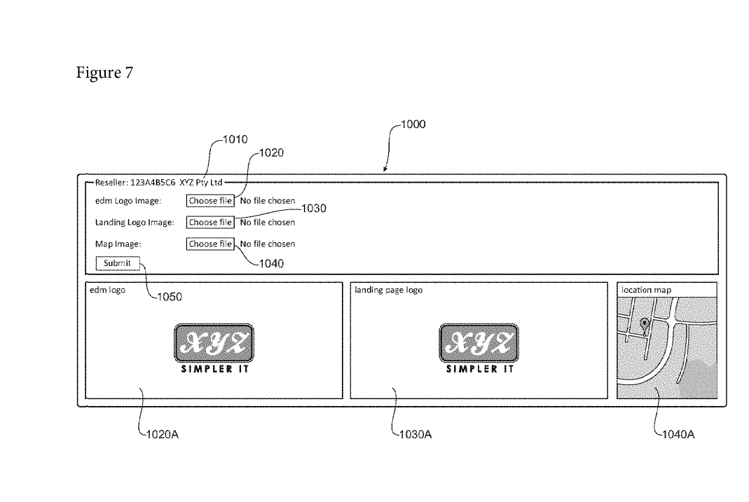

Referring now to FIG. 7, there is shown a user interface screen 1000 of the content compiler 140 illustrated in FIG. 1 for defining a template for a digital information campaign in accordance with an illustrative embodiment. In this example, the entity 1010 is “XYZ Pty Ltd”, being a reseller of computer products and services, and the digital information campaign is a digital marketing campaign comprising one or more e-newsletters with the template then defining parameters of the e-newsletter.

On selection of the entity 1010, an operator is presented with screen 1000 where they are presented with the options of being able to choose a logo image 1020, a landing logo image 1030 or a map image 1040 corresponding to the location of the entity. The corresponding logo image 1020A, landing logo image 1030A and map image 1040 are presented to the operator for checking. On selection of the appropriate images these may then be submitted 1050 to define the template. In this manner, entity template may form a non-sponsored digital content item for incorporation into a digital marketing campaign that is to be generated on behalf of the entity and sent to the entity's digital contact list.

As would be appreciated, the template defining operation may involve not only the selection of relevant images but may involve the selection of other media such as audio or video files that may be defined as part of the template. In other embodiments, the template defining operation may also involve selecting the format of, in this case, the e-newsletter including, but not limited to, aspects of the e-newsletter such as the number of columns, font, borders or reader interactive portions such as CONTACT US or LIVE CHAT that may form part of the non-sponsored digital content items of the e-newsletter.

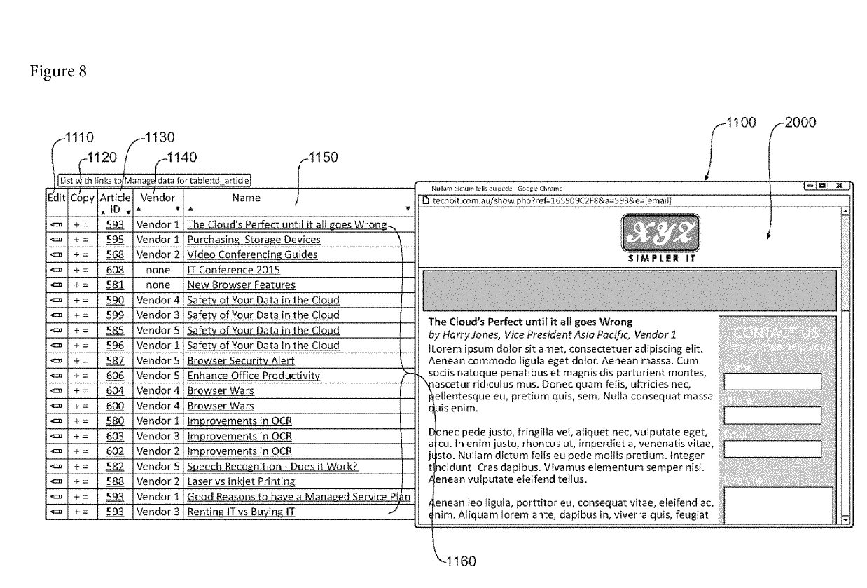

Referring now to FIG. 8, there is shown a user interface screen 1100 of the content compiler 140 illustrated in FIG. 1 for selecting and previewing a non-sponsored digital content item from the database of digital content items according to an illustrative embodiment. Selection screen 1100 is generally arranged as a series of columns with the rows corresponding to each of the non-sponsored digital content items. In this illustrative example, where the digital information campaign is an e-newsletter 2000, the non-sponsored digital content items are a collection of informative articles 1160 having title 1150 relating to the entity's business that may be incorporated into the e-newsletter.

The first column of selection screen 1100 allows an operator to edit 1110 a selected article 1160 having article identifier 1130. The second column allows an operator to copy a selected article 1160 to the e-newsletter 2000 which has been formed in accordance with the template defined by user interface screen 1000 in FIG. 7. The fourth column indicates from which sponsor that the non-sponsored content item or article 1160 originated from.

In this illustrative example, where the entity is a reseller of computer products and services, the sponsor is a vendor of these services. Even though the non-sponsored content items are in this embodiment informational, there is a linkage between what informational articles have been provided by a particular vendor or may have been generated by that vendor and are therefore appropriate for that vendor. In other examples, the article is authored by an independent author and may be applicable to multiple different vendors.

In this illustrative embodiment, the sponsor or vendor is “Vendor 1” and the article selected is article 593 titled “The Cloud is Perfect Until it All Goes Wrong”. Preview screen 1200 is then generated depicting the e-newsletter 2000 formed in accordance with the template for in this case entity “XYZ Pty Ltd” bearing the company logo and “CONTACT US” and “LIVE CHAT” windows and incorporating non-sponsored content item in the form of an informational article 593 as referred to above.

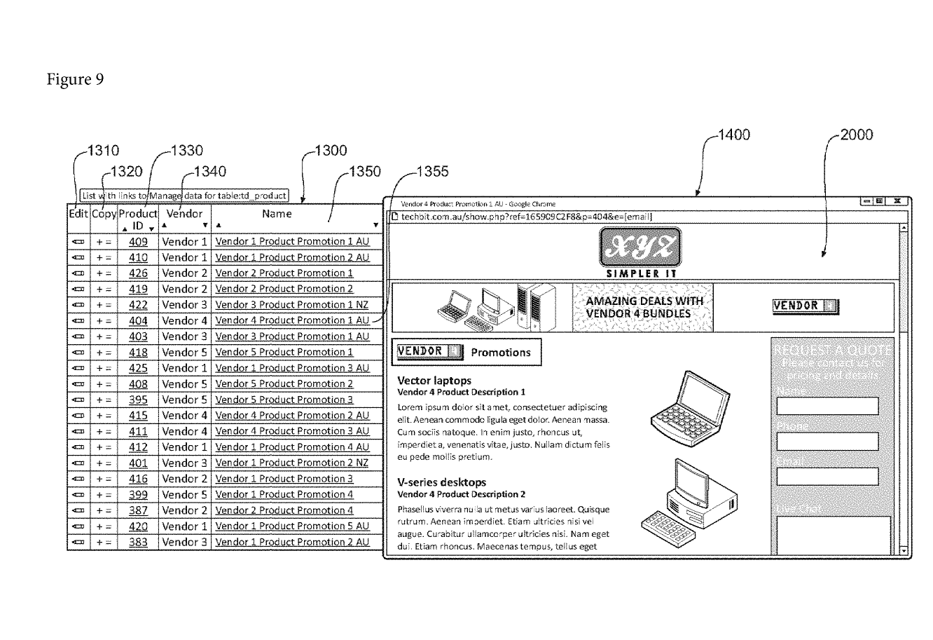

Referring now to FIG. 9, there is shown a user interface screen 1300 of the content compiler 140 illustrated in FIG. 1 for selecting a sponsored digital content item from the database of digital content items according to an illustrative embodiment. Similar to selection screen 1100 in relation to selecting non-sponsored items, selection screen 1300 is generally arranged as a series of columns with the rows corresponding to each of the sponsored digital content items.

In this example, in the context of the sponsor being a vendor of computer products or services, and the digital information campaign being an e-newsletter, the sponsored content items are typically promotional items 1350 such as product advertisements for new computers or service packages or advertising promotions in the form of competitions and the like. The first column of selection screen 1300 allows an operator to edit 1310 a selected promotional item 1355 having product identifier 1330. The second column allows an operator to copy a selected promotional item 1355 to the e-newsletter 2000 where it then may be previewed on preview screen 1400.

In this manner, e-newsletter 2000 may be generated by adding sponsored and non-sponsored content items as referred to above. In this example, preview screen 1400 displays sponsored content item 404 corresponding to Vendor 4 who is a supplier of computer hardware products such as laptop and desktop computers. In this illustrative embodiment, sponsored and non-sponsored content items are separately grouped in libraries for selection. In other embodiments, sponsored and non-sponsored content items may be grouped in further or additional libraries or sub-libraries according to criteria such as industry sector, entity type or sponsor type.

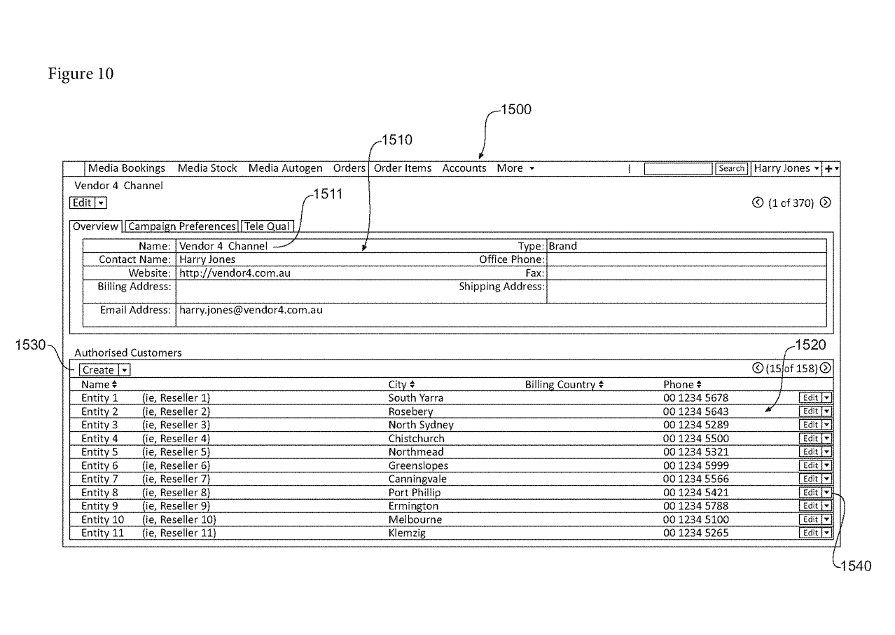

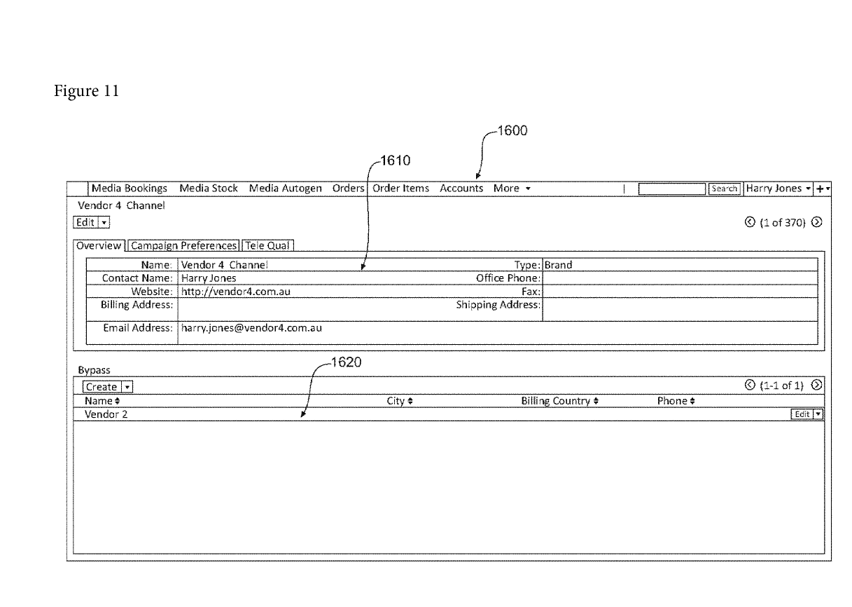

Referring now to FIG. 10, there is shown a user interface screen 1500 of the rules engine 130 illustrated in FIG. 1 for defining a composition requirement in the form of the sponsor entity relationship according to an illustrative embodiment. Sponsor entity relationship screen 1500 is selected for a particular sponsor, in this case “Vendor 4” 1511 being a vendor of computer products whose details are shown in screen portion 1510 and the “Authorized Customers” set out in rows are entities 1520 where both the sponsor and the entity have agreed that sponsored digital content items from the sponsor may form part of digital information campaigns generated on behalf of the entity 1520. An operator is able to edit and create 1530 additional entities for a given sponsor and the details of each entity 1520 may then be edited and updated 1540 as required.

In this manner, selection screens 1100 and 1300 which relate to generating the digital information campaign by content compiler 140 may only be populated with sponsored or non-sponsored content items that conform with the composition rule including the composition requirement defined by sponsor entity relationship screen 1500 of the rules engine 130.

Referring now to FIG. 11, there is shown a user interface screen 1600 of the rules engine illustrated in FIG. 1 for defining a composition requirement in the form of determining which sponsors may co-exist in a digital marketing campaign. In this example, Vendor 4 whose details are shown in screen portion 1610 is defining other sponsors whose sponsored digital content items cannot appear in a digital marketing campaign sponsored by Vendor 4. As depicted, “Vendor 4” has specified that their sponsored content cannot co-exist with sponsored digital content items from “Vendor 2” by selecting this sponsor in the “Bypass” screen portion 1620 of user interface screen 1600.

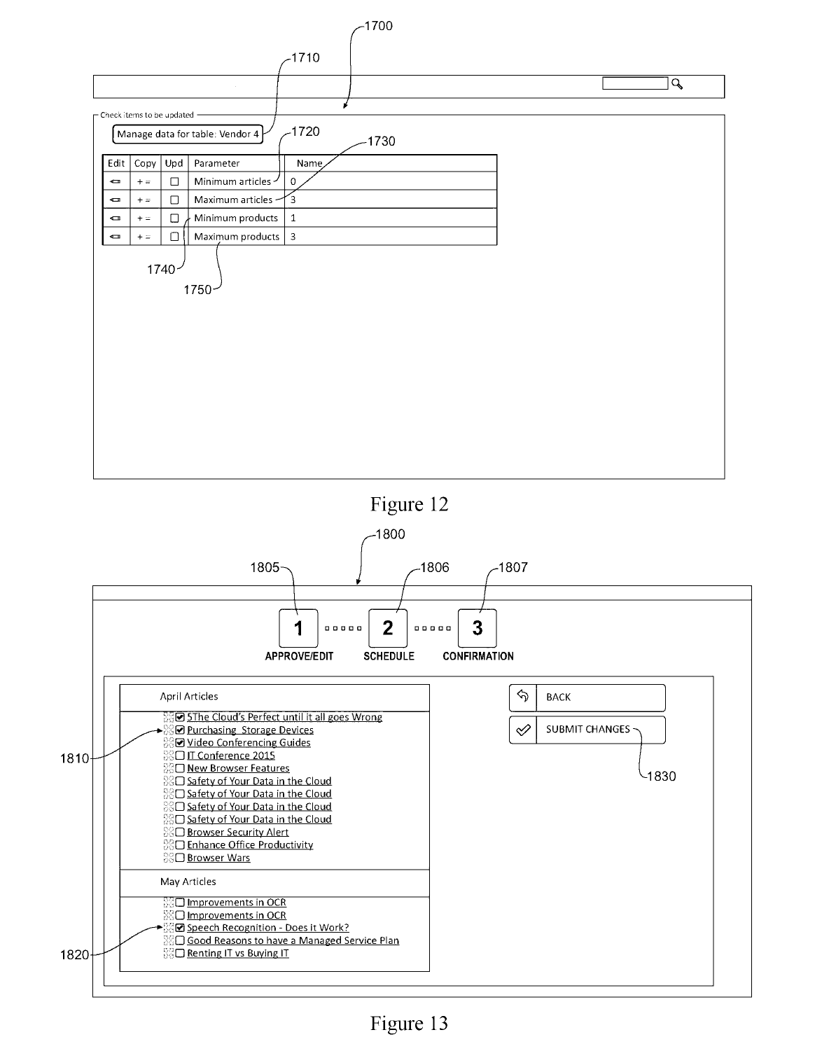

Referring now to FIG. 12, there is shown a user interface screen 1700 of the rules engine illustrated in FIG. 1 for defining a composition requirement in the form of the minimum 1720 and maximum 1730 non-sponsored digital content items (ie, “articles) and the minimum 1740 and maximum 1750 sponsored digital content items (ie, “products”) that can form part of a digital information campaign that is sponsored in this case by “Vendor 4” 1710.

Referring now to FIG. 13, there is shown a user interface screen 1800 of the approval engine 150 illustrated in FIG. 2 setting out the non-sponsored digital content items for a digital information campaign occurring over an extended time period. In this case, non-sponsored digital content items 1810 are to be included in the April component of the digital information campaign and non-sponsored digital content items 1820 are to be included in the May component of the digital information campaign.

In this illustrative embodiment, the entity may swap out the sponsored 1820 and non-sponsored 1810 content providing they adhere to any composition rule generated by the sponsor. As depicted in FIG. 13, only the “ticked” items are currently selected for the April campaign. Once the entity has adjusted or modified the digital information campaign, they then submit the changes (see the Submit Changes button 1830). The entity may then also select the date/time to schedule the campaign to be executed by accessing the schedule functionality 1806. For example, they may decide to send the email direct marketing (EDM) out on April 16 and the social posts may occur on April 17 and April 18. Once they have scheduled the campaign they receive a confirmation message 1807 that any proposed changes meet the composition rule.

As would be appreciated, embodiments of the system and method described above allow a sponsor to initiate a digital information campaign on behalf of an entity and supply content to that campaign by way of sponsored content items. In this way, the time consuming and costly task of generating the digital information campaign is transferred from the entity, whose contacts the digital information campaign will be eventually distributed to, to the sponsor who has an interest in obtaining distribution access to the entity's contact list. Furthermore, it is in the interests of the sponsor that the digital information campaign be tailored to the entity's clients, customers and/or subscribers as consumers will either ignore or be irritated by what they might otherwise perceive to be spam.

In this way, the sponsor is beneficially provided with the ability to distribute sponsored content to a contact list likely to be responsive and receptive to the content as the material will be viewed as coming from the entity. Likewise, the entity is able to better service their contact list by engaging in effective digital marketing campaigns that can provide information as well as sponsored content without compromising the confidentiality of their customer database.

In other embodiments, the systems and methods described above may be extended to generate a digital information campaign for a sponsor that involves a group of entities each having their own digital contact list. In one example, the same composition rule may be applicable to two or more entities within the group of entities while a different composition rule or rules are required for other entities. As would be appreciated, the composition rules may be electronically stored, eg, in database 110, and retrieved and modified as required.

In one example, a particular entity within the group of entities may only allow a particular class of sponsored content items and/or non-sponsored content items in the content that is going to be distributed to their digital contact list while other entities do not have this requirement. In a further embodiment, the rules engine is able to generate an entity relationship rule that specifies which entities may not be grouped together in any digital information campaign being sponsored by a particular sponsor.

In yet other embodiments, the systems and methods described above may be extended to generate individual digital information campaigns for multiple sponsors that each involves one or a group of entities for each of the digital information campaigns.

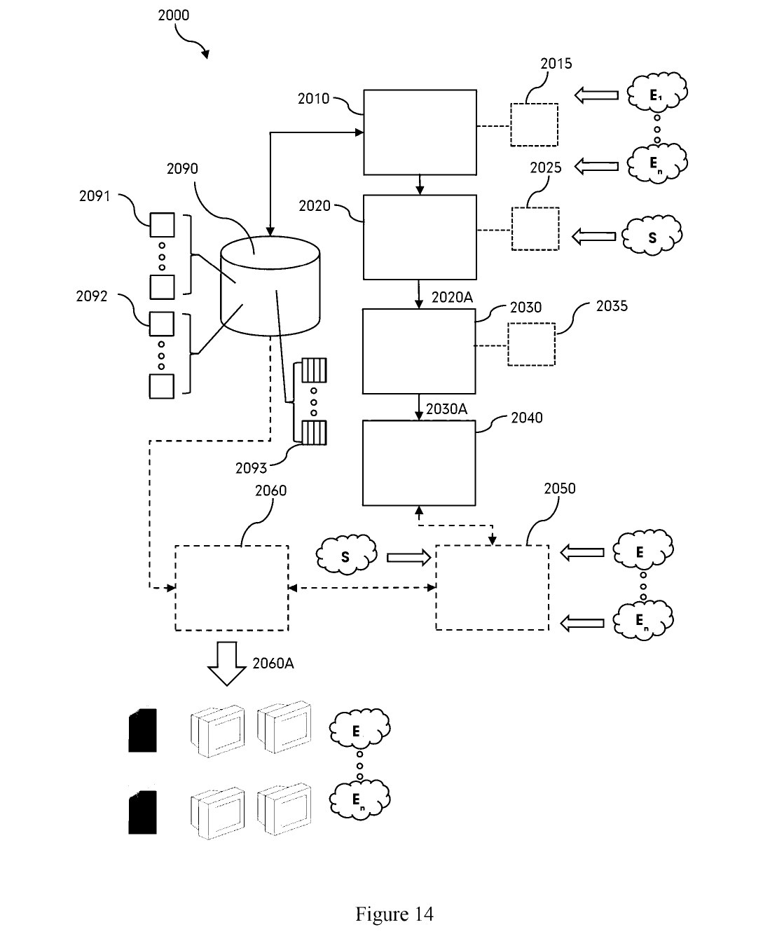

Referring now to FIG. 14, there is shown a computer-implemented system 2000 for generating a digital information campaign for distribution to the respective contact lists maintained by one or more entities E₁ to Eₙ according to an illustrative embodiment. System 2000 comprises an entity registration module 2010 for receiving information related to the entity including the respective digital contact list or customer database 2093 that is maintained by the entity which is securely stored to prevent access by the sponsor S. In this embodiment, the entity information may be entered by a user interface 2015 and stored in database server 2090.

System 2000 further includes a digital marketing campaign group compiler 2020 that determines a sponsored campaign group 2020A of entities to whom the digital information campaign will be distributed to. In this embodiment, the campaign group is determined based on matching characteristics of the one or more entities to the sponsor S who may enter their details into system 2000 by user interface 2025. In one example, the sponsor S is a wholesale supplier of goods and/or services and the entities are organisations that sell goods and/or services directly to customers. In this example, the digital campaign group compiler 2020 matches entities to a sponsor by comparing the goods and/or services sold by a respective entity which is entered on registration to those supplied by the sponsor.

In one example, this comparison can be carried out by determining the brand identifier of a product sold by an entity and matching that to a brand identifier of the sponsor. In another example, the sponsor may be matched to an entity whose most popular product is a brand manufactured or supplied by the sponsor to the entity.

In this manner, a sponsored campaign group of entities may be compiled automatically or populated by cross matching the brand of products being sold by a respective entity to the product supplied by the sponsor. As would be appreciated, matching could be carried out on any number of criteria, not necessarily commercial, such as a geographical region, market segment, and the like. In another embodiment, not only characteristics of the sponsor and the entity are matched but also characteristics of the entity's customers where that information is available.

As indicated above, digital information campaign generation system 2000 comprises a database server 2090 that further includes a database of digital content items that includes at least one sponsored content item 2091 and at least one non-sponsored content item 2092 as well as in this embodiment the respective digital contact lists 2093 of each entity which are securely stored.

Digital information campaign generation system 2000 further comprises a rules engine or module 2030 and a content compiler 2040. Rules engine 2030 allows the sponsor of the digital information campaign to generate a composition rule 2030A that determines the composition of the digital information campaign based on the database 2090 of digital content items, the sponsor S and the sponsored campaign group 2020A whose respective digital contact lists 2093 the digital information campaign will be delivered or distributed to. In this embodiment, rules engine 2030 includes a graphical user interface implemented on display 2035 for the sponsor, or an operator acting on behalf of the sponsor, to generate the composition rule which will be comprised of one or more composition requirements as has been discussed previously. Content compiler 2040 then generates the digital marketing campaign in accordance with the composition rule 2030A and the sponsored campaign group 2020A for distribution to respective digital contact lists maintained by one or more entities.

As has been discussed previously, digital information campaign generation system 2000 may further comprise an approval engine or module 2050 to allow approval of the digital marketing campaign by either the sponsor or one or more of the entities as has been previously described. Similarly, system 2000 may further comprise a distribution engine or module 2060 that has secure access to the respective digital contact lists 2093 that functions to distribute the digital marketing campaign 2060A to the respective digital contact lists of the entities in the sponsored campaign group 2020A as previously described.

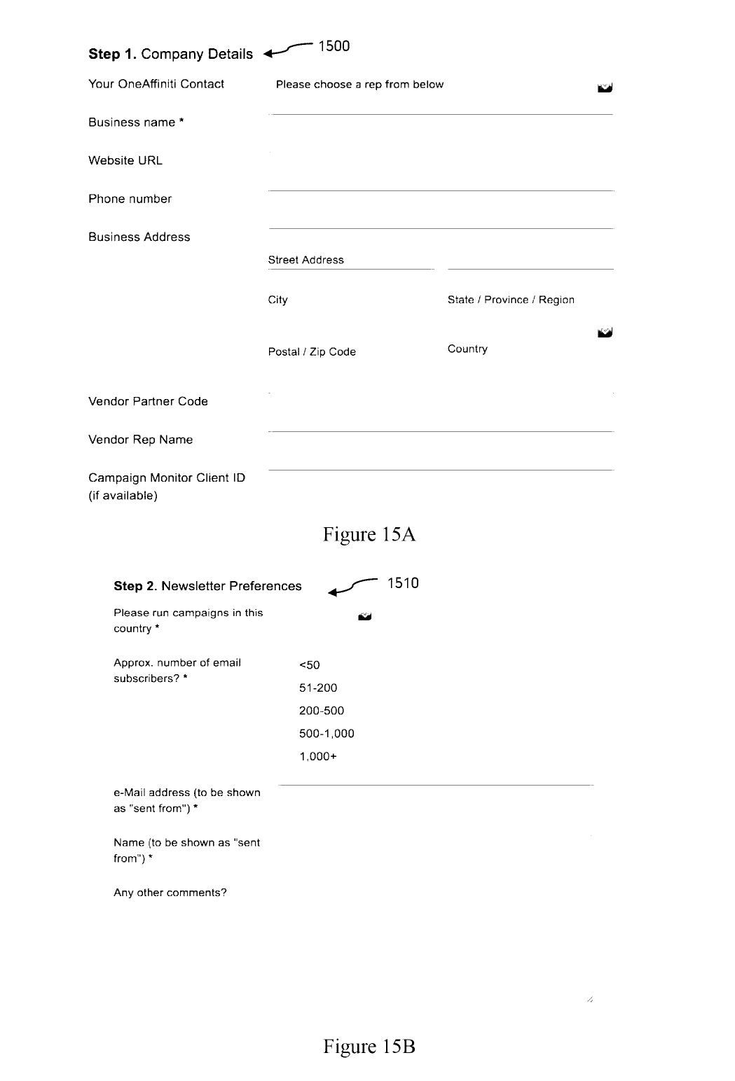

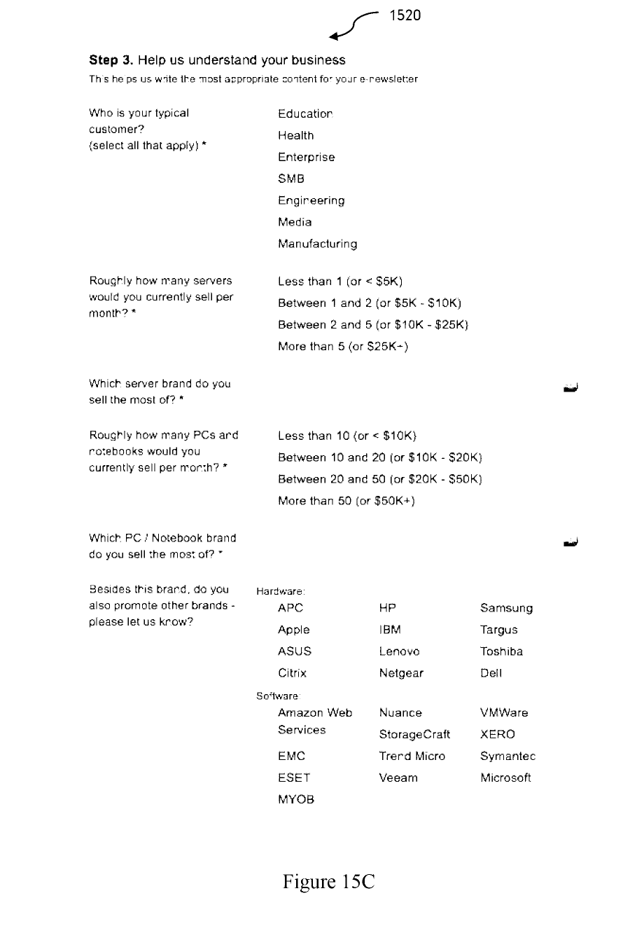

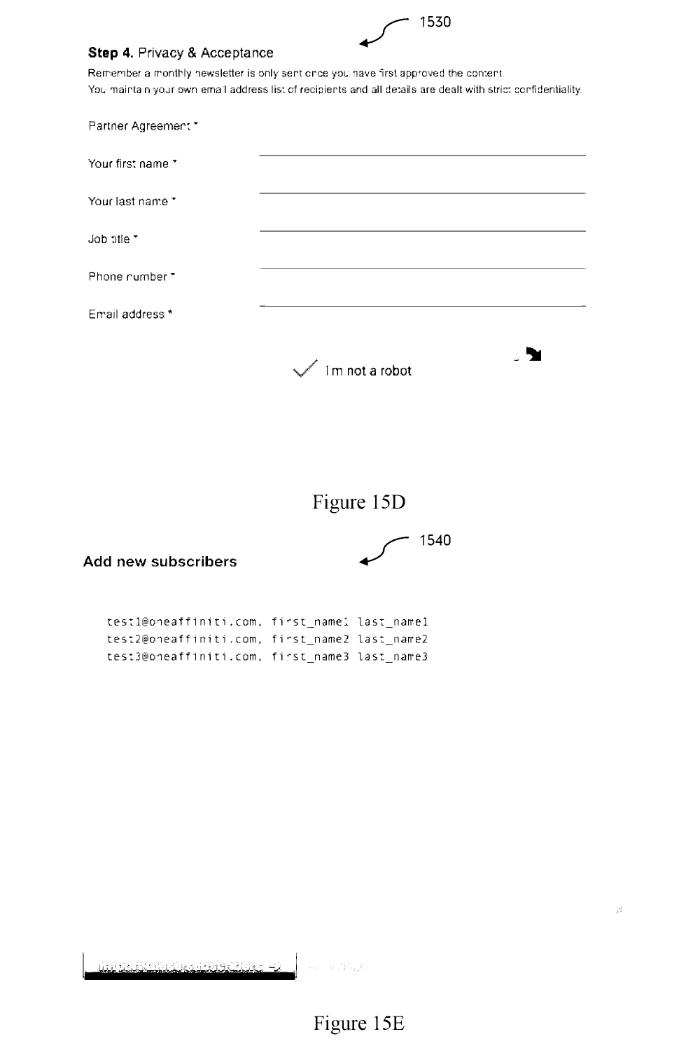

Referring now to FIGS. 15A-E, there are shown a series of example user interface screens that would be displayed on suitable electronic display for an entity registration module. In this example, directed to a digital information campaign for the computer retail market, an entity enters contact information into a “Company Details” user screen 1500 as shown in FIG. 15A as part of the registration process. Following this step, an entity then enters information in relation to the type of digital marketing campaign that they wish to participate in. In this example, the digital marketing campaign is an electronic HTML based newsletter as previously described and the details of the type of digital marketing campaign are entered in a “Newsletter Preferences” user screen 1510 as shown in FIG. 15B.

As can be seen from inspection, user interface screen 1510 allows an entity to specify which country a digital marketing campaign should be run in and the approximate number of subscribers or members of the digital contact list that the entity has. In this example, the entity also enters the email address and the name which is shown in the “sent from” field as the newsletter or digital information campaign will be sent on behalf of the entity.

Further information relating to the goods and/or services sold by the entity and their customers is collected by the “Help us understand your business” user interface screen 1520 as depicted in FIG. 15C. As can be seen from inspection, user interface screen 1520 allows an entity to indicate who their typical customer or customers are, how many computers servers are sold per month, what computer server brand is the most popular, the number of personal computers (PCs) and laptops that are sold per month and which PC/Notebook is the most popular. In this example user interface screen, information is also sought as to which other brands are promoted or sold by the entity, and the entity is provided with a checkbox list of various brands in the hardware and software product range.

As would be appreciated, the business characteristics user interface screen 1520 may be customised according to the market that the goods and/or services of the sponsor and the entity is directed to. As an example, if the relevant market was the supply of medical equipment then the customer details options may comprise different types of health providers, eg, sole practitioners, private medical practices, clinics, private hospitals or public/teaching hospitals. Similarly, the questions directed to servers, notebooks and PCs would be directed to the relevant medical equipment, eg diagnostic machines. Similarly, the brand request form or checklist would comprise those brands active in the relevant medical equipment area.

Registration of the entity is then finalised with the “Privacy and Acceptance” user interface screen 1530 shown in FIG. 15D, where a representative of the entity provides their own personal contact details and agrees to become part of the digital information campaign system 2000. As noted in user interface screen 1530, the entity is able to maintain their own digital contact list, or in this case their email address list of recipients or subscribers within the system 2000 with this proprietary information of the entity then dealt with in strict confidentiality within system 2000 as has been previously described.

Referring now to FIG. 15E, there is shown an “Add new subscribers” user interface screen 1540, where an entity can provide the digital contact list, which in this exemplary embodiment comprises email address, either by entering manually into the system or alternatively by importing them from a file.

In this manner, the entity registration module 2010 receives and stores entity information related to the entity including the secure storage of the digital contact list 2093 that is maintained by the entity (eg, see FIG. 14). This allows the digital marketing campaign generation system to compile a group of entities that matches a sponsor to form a sponsored campaign group. In the case of a computer reseller, the sponsor may be the supplier of a particular computer server, either as a wholesale supplier or manufacture, and the sponsored campaign group consists of the one or more entities meeting the requirements of selling more than $10K of servers in a month and whose most popular sold server matches the brand of the computer server supplied by the sponsor (see FIG. 15C and user interface screen 1520).

In this way, a sponsored campaign group may be formed by the digital information campaign group compiler 2020 consisting of the entities whose customers are more likely to be receptive to the sponsor's sponsored digital marketing content as they are already known to source and buy the sponsor's product from the entities. As would be appreciated, a sponsor may use the information obtained from the entity registration module 2010 to compile different sponsored campaign groups 2020A. As an example, particular sponsored digital content may be more suitable to smaller types of entities directed to the home PC market, whereas other sponsored digital content may be more relevant to the large commercial computer server market. These requirements may then be specified in the composition rule 2030A generated by the sponsor relevant to the sponsored campaign group 2020A.

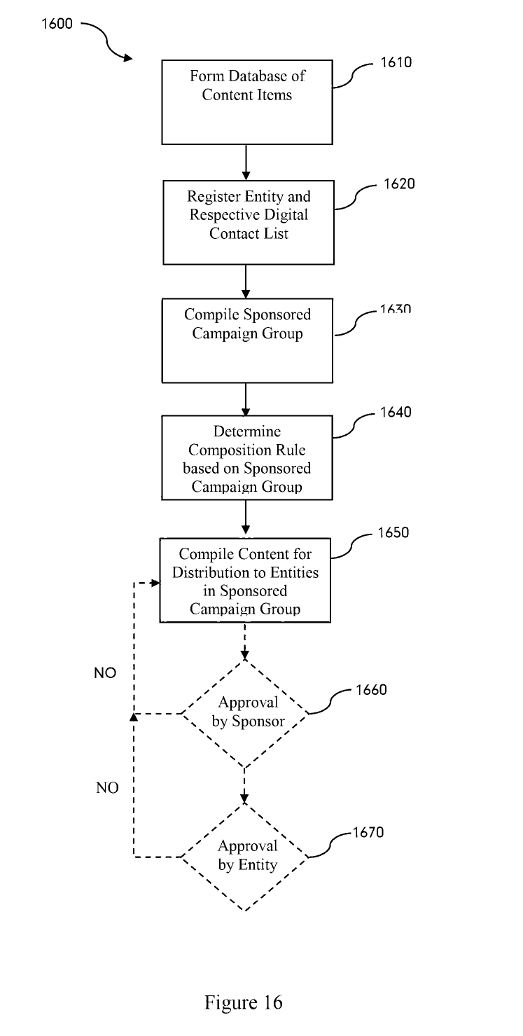

Referring now to FIG. 16, there is shown a flowchart of an illustrative method 1600 for generating a digital information campaign on behalf of one or more entities for distribution to respective digital contact lists maintained by the one or more entities, wherein the digital information campaign is sponsored by a sponsor.

In this example, the digital information campaign is initiated by a sponsor seeking to distribute targeted sponsored material to a group of entities that have been matched to the sponsor in accordance with one or more criteria. In one embodiment, the sponsor is matched to the group of entities based on the brand of product supplied by the sponsor, eg, as a wholesale supplier or manufacturer, and the brand of products sold by the entity to a consumer. In another embodiment, the group of entities may be selected based on the type of sponsor's product sold and/or the segment of the market that the sponsor's product is sold to. In this manner, the sponsor, which includes their agents or third party implementers authorised to act on the sponsor's behalf, facilitates the generation of the digital information campaign for each entity in the sponsored campaign group in satisfaction for access to the respective digital contact list of each entity.

At step 1610, a database of content items is formed which includes one or more sponsored and non-sponsored content items as has been previously discussed.

At step 1620, a plurality of entities is registered and the respective entity information is received and stored including each digital contact list maintained by each entity which is securely stored and cannot be accessed by the sponsor.

At step 1630, a sponsored campaign group consisting of the one or more entities selected from the plurality of registered entities is compiled based on matching the one or more entities to the sponsor.

At step 1640, a composition rule is generated by the sponsor that determines the composition of the digital marketing campaign. Here the sponsor ensures that any digital marketing campaign will include at least one sponsored content item without necessarily stipulating which particular sponsored content item is to form part of the digital information campaign.

At step 1650, the digital information campaign is compiled in accordance with the composition rule. At steps 1660 and 1670, there are optional approval processes for approval by either the sponsor and/or the entity as has been discussed previously. Once the digital information campaign has been compiled it may then be distributed or sent to the respective digital contact lists of the entities that make up the sponsored campaign group.

Those of skill in the art would appreciate that the various illustrative logical blocks, modules, circuits, and algorithm steps described in connection with the embodiments disclosed may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As an example, entity registration module 2010, campaign group compiler 2020, rules engine 130, 2030, content compiler 140, 2040, approval engine 150, 2050 and/or distribution engine 180, 2060 may be developed in PHP, .NET, Python, Ruby, Java or similar language and run on a digital computer such as a laptop, desktop, workstation, mobile device or any other appropriate computer or processor. In one example embodiment, the digital computer may be based on an x86 processor running Windows, Linux or other variations of UNIX. Entity registration module 2010, campaign group compiler 2020, rules engine 130, 2030, content compiler 140, 2040, approval engine 150, 2050 and/or distribution engine 180, 2060 may be run as separate applications on a single digital computer or processor or be distributed over a number of digital computers or processors depending on requirements. In an alternative embodiment, entity registration module 2010, campaign group compiler 2020, rules engine 130, 2030, content compiler 140, 2040, approval engine 150, 2050 and/or distribution engine 180, 2060 may be implemented as separate capabilities within a single application.

The systems and methods described here may be implemented in a computing system that includes a back end component (eg, a data server), or that includes a middleware component (eg, an application server), or that includes a front end component (eg, a client computer having a graphical user interface or a Web browser through which a user can interact with the system, or any combination of such back end, middleware, or front end components. The components of the system may be interconnected by any form or medium of digital data communication (eg, a communication network). Examples of communication networks include a local area network (“LAN”), a wide area network (“WAN”), peer-to-peer networks (having ad-hoc or static members), grid computing infrastructures, and the Internet.

The computing system may be implemented as a client-server arrangement where the clients and server are generally remote from each other and typically interact through a communication network. The relationship of client and server arises by virtue of computer programs running on the respective computers and having a client-server relationship to each other. In one example of a client-ser er arrangement the server may be a web server running Apache or a similar Internet-enabled service to allow remote access by operators employing web browsers operable to access and interact with the described system.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application described. Neither is the present disclosure restricted in its preferred embodiment with regard to the particular elements and/or features described or depicted here. It will be appreciated that the disclosure is not limited to the embodiment or embodiments disclosed, but is capable of numerous rearrangements, modifications and substitutions without departing from the scope of the invention as set forth and defined by the following claims.

1. A computer-implemented system for generating a digital information campaign on behalf of an entity for distribution to a digital contact list maintained by the entity, comprising:
a database server comprising a database of digital content items, the database comprising at least one sponsored digital content item originating from a sponsor of the digital information campaign and at least one non-sponsored content item;
a rules engine for the sponsor programmed or configured to generate a composition rule for determining a composition of the digital information campaign based on the database of digital content items, the sponsor and the entity, the composition rule of the digital marketing campaign comprising at least one sponsored content item to be included in the digital marketing campaign; and
a content compiler programmed or configured to generate the digital marketing campaign in accordance with the composition rule.

2. The computer-implemented system of claim 1, wherein the system further comprises an approval engine for approving the digital marketing campaign.

3. The computer implemented system of claim 2, wherein the content compiler is operated by the entity and programmed or configured to generate the digital marketing campaign in accordance with the composition rule for approval by the sponsor.

4. The computer implemented system of claim 2, wherein the content compiler is operated by the sponsor and programmed or configured to generate the digital marketing campaign in accordance with the composition rule for approval by the entity.

5. The computer-implemented system of claim 1, wherein the digital contact list is securely stored to prevent access by the sponsor on the database server, and wherein the system further comprises a distribution engine programmed or configured to distribute the digital marketing campaign to the digital contact list of the entity.

6. The computer-implemented system of claim 1, wherein the at least one sponsored digital content item promotes a product and/or service provided by the sponsor.

7. The computer-implemented system of claim 1, wherein the composition rule comprises one or more composition requirements.

8. The computer-implemented system of claim 7, wherein the composition requirement defines a content characteristic of the digital information campaign.

9. The computer implemented system of claim 8, wherein the composition requirement comprises at least one of the following:
default content to be included in the digital information campaign;
one or more non-sponsored digital content items to be included in the digital information campaign;
one or more classes or libraries of sponsored and/or non-sponsored digital content items to be included in the digital information campaign;
identifying one or more sponsored and/or non-sponsored digital content items not to be included in the digital information campaign;
identifying one or more classes or libraries of sponsored and/or non-sponsored digital content items not to be included in the digital information campaign
specifying a time period for which a sponsored or non-sponsored digital content item may be included in a digital information campaign;
specifying an order in which sponsored or non-sponsored digital content items may be distributed or published in a digital information campaign;
specifying the minimum or maximum number of sponsored and/or non-sponsored digital content items to be included in the digital campaign;
or any combination thereof.

10. The computer-implemented system of claim 7, wherein the composition requirement defines a relationship between a sponsor and an entity.

11. The computer implemented system of claim 10, wherein the composition requirement comprises at least one of the following:
identifying those entities who will not accept or publish sponsored and/or non-sponsored digital content items from a sponsor;
identifying those entities who a sponsor will not generate a digital information campaign on behalf of;
specifying for an entity the level of editorial control that they may have over the digital information campaign;
or any combination thereof.

12. The computer-implemented system of claim 7, wherein the composition requirement defines a relationship between a sponsor and another sponsor.

13. The computer implemented system of claim 12, wherein the composition requirement comprises identifying a coexistence relationship between sponsors.

14. The computer-implemented system of claim 1, wherein the digital marketing campaign comprises at least one email, and wherein the digital contact list comprises email addresses.

15. The computer-implemented system of claim 1, wherein the digital marketing campaign comprises at least one social media post, and the digital contact list comprises social media handles or usernames.

16. A computer-implemented system for generating a digital information campaign on behalf of an entity for distribution to a digital contact list maintained by the entity, comprising:
a database server comprising a database of digital content items, the database comprising at least one sponsored digital content item originating from a sponsor of the digital information campaign and at least one non-sponsored content item;
computer memory holding computer program instructions in communication with one or more processors that when executed by the one or more processors, cause the one or more processors to perform operations comprising:
initiating a rules engine communicatively coupled to the database server and having a user interface for the sponsor to generate a composition rule for determining a composition of the digital information campaign based on the database of digital content items, the sponsor and the entity, the composition rule of the digital marketing campaign comprising at least one sponsored content item to be included in the digital marketing campaign; and
initiating a content compiler communicatively coupled to the database server and programmed or configured to generate the digital marketing campaign in accordance with the composition rule.

17. The computer-implemented system of claim 16, wherein the one or more processors perform operations comprising:
securely storing the digital contact list to prevent access by the sponsor on the database server; and
distributing the digital marketing campaign to the digital contact list of the entity.

18. A system for generating a digital information campaign on behalf of an entity for distribution to a digital contact list maintained by the entity, comprising:
a database server comprising one or more processors and comprising a database of digital content items, the database comprising at least one sponsored digital content item originating from a sponsor of the digital information campaign and at least one non-sponsored content item;
a rules engine module comprising one or more processors and communicatively coupled to the database, the rules engine module programmed or configured to generate a composition rule for determining a composition of the digital information campaign based on the database of digital content items, the sponsor and the entity, the composition rule of the digital marketing campaign comprising at least one sponsored content item to be included in the digital marketing campaign;
a content compiler module comprising one or more processors and communicatively coupled to the database server, the content compiler module programmed or configured to generate the digital marketing campaign in accordance with the composition rule.

19. The system of claim 18, wherein the digital contact list is securely stored to prevent access by the sponsor on the database server and further comprising a distribution module comprising one or more processors and communicatively coupled to the content compiler module and the database server, the distribution module programmed or configured to distribute the digital marketing campaign to the digital contact list of the entity.

20. A computer-implemented method for generating a digital information campaign on behalf of an entity for distribution to a digital contact list maintained by the entity, comprising:
forming a database of digital content items, the database comprising at least one sponsored content item originating from a sponsor of the digital information campaign and at least one non-sponsored content item;
generating, by the sponsor, a composition rule programmed or configured to determine a composition of the digital information campaign based on the database of digital content items, the sponsor and the entity, the composition rule of the digital marketing campaign comprising at least one sponsored content item to be included in the digital marketing campaign;
generating the digital marketing campaign in accordance with the composition rule.

21. The computer-implemented method of claim 20, further comprising approving, by the sponsor, the digital marketing campaign.

22. The computer-implemented method of claim 20, further comprising approving, by the entity, the digital marketing campaign.

23. The computer-implemented method of claim 20, further comprising:
securely storing the digital contact list to prevent access by the sponsor; and
distributing the digital marketing campaign to the digital contact list.

24. A computer-implemented method for generating a digital information campaign on behalf of an entity for distribution to a digital contact list maintained by the entity, comprising:
forming a database of digital content items on a database server, the database comprising at least one sponsored content item originating from a sponsor of the digital information campaign and at least one non-sponsored content item;
generating, by the sponsor, on one or more processors communicatively coupled to the database a composition rule programmed or configured to determine a composition of the digital information campaign based on the database of digital content items, the sponsor and the entity, the composition rule of the digital marketing campaign comprising at least one sponsored content item to be included in the digital marketing campaign; and
generating, by the one or more processors communicatively coupled to the database, the digital marketing campaign in accordance with the composition rule.

25. The computer-implemented method of claim 24, further comprising securely storing the digital contact list to prevent access by the sponsor on the database server and distributing, by the one or more processors, the digital marketing campaign to the digital contact list of the entity.

26. The digital information campaign formed in accordance with claim 20.

27. A computer-implemented system for generating a digital information campaign on behalf of one or more entities for distribution to respective digital contact lists maintained by the one or more entities, wherein the digital information campaign is sponsored by a sponsor, the system comprising:
an entity registration module programmed or configured to register a plurality of entities, wherein the entity registration module receives and stores entity information related to each entity comprising the respective digital contact list maintained by each entity, wherein the respective digital contact list is securely stored to prevent access by the sponsor;
a digital information campaign group compiler programmed or configured to determine a sponsored campaign group comprising one or more entities based on matching the one or more entities to the sponsor;
a database server comprising a database of digital content items, the database comprising at least one sponsored digital content item originating from the sponsor and at least one non-sponsored content item;
a rules engine for the sponsor programmed or configured to generate a composition rule for determining a composition of the digital information campaign based on the database of digital content items, the sponsor and the sponsored campaign group, the composition rule of the digital marketing campaign comprising at least one sponsored content item to be included in the digital information campaign; and
a content compiler programmed or configured to generate the digital information campaign in accordance with the composition rule and the sponsored campaign group for distribution to respective digital contact lists maintained by one or more entities.

28. The computer-implemented system of claim 27, wherein the sponsor is a supplier of goods and/or services to the one or more entities and the one or more entities directly sell goods and/or services to consumers.

29. The computer-implemented system of claim 28, wherein the entity information comprises the goods and/or services sold by the entity and matching the one or more entities and the sponsor comprises comparing the goods and/or services sold by a respective entity and those supplied by the sponsor.

30. The computer-implemented system of claim 29, wherein comparing the goods and/or services sold by the respective entity comprises determining a brand identifier of a product sold by the respective entity and matching that to a brand identifier of the sponsor to determine the sponsored campaign group.

31. The computer-implemented system of claim 27, wherein the system further comprises a distribution engine programmed or configured to distribute the digital marketing campaign to the digital contact list of the entity.

32. A computer-implemented method for generating a digital information campaign on behalf of one or more entities for distribution to respective digital contact lists maintained by the one or more entities, wherein the digital information campaign is sponsored by a sponsor, comprising:
forming a database of digital content items on a database server, the database comprising at least one sponsored content item originating from a sponsor of the digital information campaign and at least one non-sponsored content item;
registering a plurality of entities by receiving and storing entity information related to each entity comprising the respective digital contact list maintained by each entity, wherein the respective digital contact lists are securely stored to prevent access by the sponsor;
matching the one or more entities to the sponsor to compile a sponsored campaign group;
generating a composition rule programmed or configured to determine a composition of the digital information campaign based on the database of digital content items, the sponsor and the sponsored campaign group, the composition rule of the digital marketing campaign comprising at least one sponsored content item to be included in the digital marketing campaign; and
generating the digital marketing campaign in accordance with the composition rule.

33. The computer-implemented method of claim 32, wherein the sponsor is a supplier of goods and/or services to the one or more entities and the one or more entities directly sell goods and/or services to consumers.

34. The computer-implemented method of claim 33, wherein the entity information comprises the goods and/or services sold by the entity and matching the one or more entities to the sponsor comprises comparing the goods and/or services sold by a respective entity and those supplied by the sponsor.

35. The computer-implemented system of claim 34, wherein comparing the goods and/or services sold by the respective entity comprises determining a brand identifier of a product sold by the respective entity and matching that to a brand identifier of the sponsor to determine the sponsored campaign group.

36. The computer-implemented method of claim 32, further comprising approving by the sponsor the digital marketing campaign.

37. The computer-implemented method of claim 32, further comprising approving by the entity the digital marketing campaign.

38. The computer-implemented method of claim 32, further comprising distributing the digital marketing campaign to the respective digital contact lists of the one or more entities.

39. The digital information campaign formed in accordance with the method of claim 24.
